(19) United States
(12) Patent Application Publication
(10) Pub. No.: US 2025/0074336 A1
(43) Pub. Date: Mar. 6, 2025

(54) SOUND ABSORPTION AND INSULATION MODULE FOR VEHICLE

(71) Applicants: Hyundai Motor Company, Seoul (KR); Kia Corporation, Seoul (KR)

(72) Inventor: Seong Su SHIN, Cheongju-si (KR)

(21) Appl. No.: 18/422,790

(22) Filed: Jan. 25, 2024

(30) Foreign Application Priority Data
Sep. 5, 2023 (KR) 10-2023-0117598

(51) Int. Cl. B60R 13/08

(52) U.S. Cl. CPC B60R 13/0815; B60R 13/083; B60R 13/0838; B60R 13/0861

(57) ABSTRACT

A sound absorption and insulation module for a vehicle includes a perforated panel that defines a plurality of holes, a sound absorption material, and a sound insulation material. The perforated panel, the sound absorption material, and the sound insulation material are sequentially coupled. A diameter of the holes, a number of the holes, and a distance between the holes are determined based on noise frequency bands, thereby effectively responding to noises in various frequency bands generated from one or more portions of a specific component of the vehicle.

### CROSS REFERENCE TO RELATED APPLICATION

The present application claims priority of Korean Patent Application No. 10-2023-0117598, filed on Sep. 5, 2023, the entire contents of which are incorporated herein for all purposes by reference.

### TECHNICAL FIELD

The present disclosure relates to a sound absorption and insulation module for a vehicle, and more specifically, to a technology related to a sound absorption and insulation module for a vehicle, which may effectively respond to noises in various frequency bands for each portion in a specific component.

### BACKGROUND

Vehicles have various noise sources such as a tire, an engine, a transmission, a motor, an inverter, a road noise, and a wind noise.

In order to effectively absorb and insulate these noises, various sound absorption and insulation systems, such as a partition wall, a wheel guard, a body insulator, an interior isolation pad, and active noise control, are being applied throughout a vehicle.

For example, sound absorption and insulation systems may include a combination of a porous sound absorption material and sound insulation material and have applied inefficient countermeasures such as adding the sound absorption material to a portion or increasing a thickness of the entire sound absorption and insulation material in order to respond to frequency components (a motor order component, an inverter specific component, a resonance frequency component of a specific component, and the like) causing noises in the specific portions.

In some cases, the conventional sound absorption and insulation systems may have a disadvantage in that an assembling cost of an additional sound absorption material increases, and the weight and cost thereof increases due to an increase in the thickness of the entire sound absorption and insulation material, and in particular, have a disadvantage in that it is not possible to effectively respond to noises in various frequency bands for each portion in the specific component.

### SUMMARY

The present disclosure is directed to providing a sound absorption and insulation module for a vehicle including a perforated panel in which a plurality of holes are formed, which may effectively respond to noises in various frequency bands for each portion in a specific component and in particular, make the entire sound absorption and insulation system slimmer, thereby reducing the weight and cost thereof.

According to one aspect of the subject matter described in this application, a sound absorption and insulation module for a vehicle includes a perforated panel that defines a plurality of holes, a sound absorption material that is porous and disposed on the perforated panel, and a sound insulation material disposed on the sound absorption material.

One surface of the sound absorption material may be laminated by being bonded and coupled to one surface of the perforated panel, and one surface of the sound insulation material may be laminated by being bonded and coupled to the other surface of the sound absorption material.

The holes formed in the perforated panel may be formed so that a size of a diameter of the hole, the number of the holes, and a distance between the holes are different in one target component that is a noise removal object.

A noise frequency of the sound absorbed while passing through the holes formed in the perforated panel may be determined by the size of the diameter of the hole, the distance between the holes, and a cross-sectional thickness of the perforated panel.

The holes of the perforated panel may be formed through a first operation of checking a frequency component and a sound pressure intensity of a noise source for each portion in one target component that becomes a noise removal object, a second operation of classifying a frequency component for each portion in the target component with a result value obtained through the first operation, a third operation of selecting a layout of the hole suitable for the frequency component for each portion classified in the second operation, and a fourth operation of performing perforation on each portion of the target component after reflecting the result of the third operation.

The perforated panel may be manufactured by press-molding a perforated panel formed by perforating a metal panel, the sound absorption material is manufactured by molding a glass fiber, the sound insulation material is manufactured by injection-molding polypropylene, and the perforated panel, the sound absorption material, and the sound insulation material are sequentially coupled.

The perforated panel may have a porosity of 0.5 to 3% in a condition in which a cross-sectional thickness is in a range of 0.5 to 3 mm, a distance between the holes is in a range of 3 to 8 mm, and a diameter of the hole is in a range of 0.5 to 1 mm and may be sequentially formed together with the sound absorption material and the sound insulation material to eliminate a noise in a specific frequency in a range of 1 to 3 KHz.

The perforated panel may have a porosity of 2 to 11% in a condition in which a cross-sectional thickness is in a range of 0.5 to 3 mm, a distance between the holes is in a range of 1.5 to 4 mm, and a diameter of the hole is in a range of 0.5 to 2 mm and may be sequentially formed together with the sound absorption material and the sound insulation material to eliminate a noise in a specific frequency in a range of 3 to 7 KHz.

The perforated panel may have a porosity of 10% or more in a condition in which a cross-sectional thickness is in a range of 0.5 to 3 mm, a distance between the holes is in a range of 0.5 to 4 mm, and a diameter of the hole is in a range of 0.2 to 2 mm and may be sequentially formed together with the sound absorption material and the sound insulation material to eliminate a noise in a specific frequency in a range of 7 to 10 KHz.

The module in which the perforated panel, the sound absorption material, and the sound insulation material are integrally coupled may be applied to at least one of an insulator, a partition wall or encapsulation, a carpet and an isolation pad, and a wheel guard of the vehicle.

The perforated panel may be made of a material other than metal having a larger hardness than the sound absorption material and the sound insulation material.

The sound absorption and insulation module for a vehicle may have the configuration in which the perforated panel in which the plurality of holes are formed, the sound absorption material, and the sound insulation material are sequentially coupled integrally, and the holes of the perforated panel are formed so that the size of the diameter of the hole, the number of holes, and the distance between the holes are different for each portion having the noises in the different frequency bands, and effectively respond to all of the noises in the different frequency bands for each portion in the specific component and in particular, make the entire sound absorption and insulation system slimmer, thereby reducing the weight and cost thereof.

In some implementations, it is possible to target the sound absorption coefficient of the specific portion and the specific frequency using the impedance characteristics of the perforated panel that are different for each portion, thereby constituting the optimal sound absorption and insulation system suitable for the sound characteristics of the target noise source.

In some implementations, it is advantageous in reducing the noises by decreasing the weights of the sound absorption material and the sound insulation material as much as the weight of the perforated panel newly added to the conventional structure, and by changing only the layout of the hole of the perforated panel while maintaining the sound absorption material and the sound insulation material as it is when the noise source is changed, it is possible to secure the countermeasure for suppressing noises and vibrations.

In some implementations, it is possible to reduce the content of the glass fiber compared to the conventional sound absorption and insulation structure due to the increase in the sound absorption coefficient caused by applying the perforated panel, thereby reducing human harm and achieving the excellent eco-friendly property.

### BRIEF DESCRIPTION OF THE DRAWINGS

The above and other objects, features and other advantages of the present disclosure will be larger clearly understood from the following detailed description when taken in conjunction with the accompanying drawings.

FIG. 1 is a view illustrating an example of a sound absorption and insulation module for a vehicle.

FIGS. 2 to 6 are views for describing an example of a process for defining a hole in a perforated panel.

FIGS. 7 to 13 are views for describing an example of a process for manufacturing the sound absorption and insulation module.

FIGS. 14 to 17 are views for describing example portions of a vehicle including the sound absorption and insulation module.

### DETAILED DESCRIPTION

Hereinafter, implementations disclosed in this specification will be described in detail with reference to the accompanying drawings, and the same or similar components are denoted by the same reference numerals regardless of the drawing symbols, and overlapping descriptions thereof will be omitted.

In the disclosure, a unit or control unit included in the name of a motor control unit (MCU), a hybrid control unit (HCU), or the like is the term widely used for naming a controller for controlling a specific function of a vehicle and may not mean a generic function unit.

A controller may include a communication device for communicating with another controller or a sensor to control a function in charge, a memory for storing an operating system or logic commands and input and output information, and one or more processors for performing determination, calculation, decision, and the like for controlling the function in charge.

Hereinafter, a sound absorption and insulation module for a vehicle according to an example implementation of the present disclosure will be described with reference to the accompanying drawings.

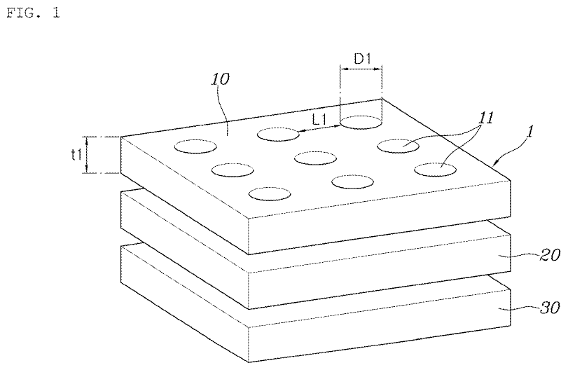

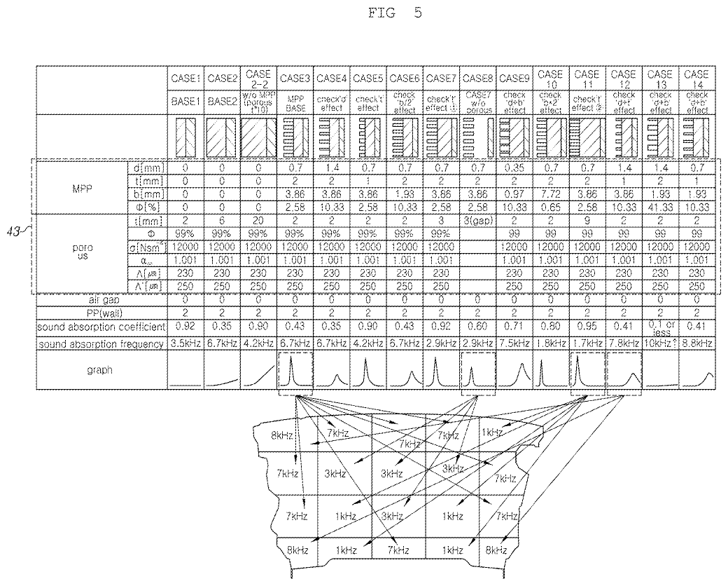

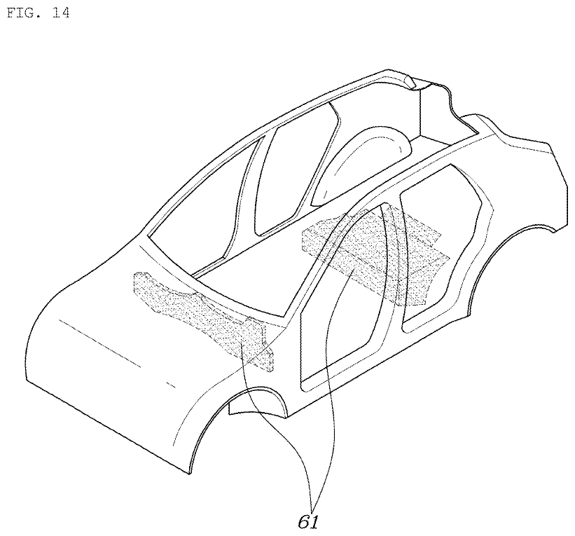

As illustrated in FIGS. 1 to 17, a sound absorption and insulation module 1 for a vehicle includes a perforated panel 10 in which a plurality of holes 11 are formed, a porous sound absorption material 20 laminated on the perforated panel 10, and a sound insulation material 30 laminated on the sound absorption material 20.

In some implementations, the perforated panel 10 may be formed of a metal panel with a predetermined cross-sectional thickness, the porous sound absorption material 20 may be made of a polyurethane (PU) foam and a glass fiber (or a glass wool), and the sound insulation material 30 may be made of polypropylene (PP).

The present disclosure has a configuration capable of maximizing only sound absorption and insulation performance of a target frequency component by filtering a specific frequency component of a noise passing through micro holes 11 of the perforated panel 10 and may provide various types of sound absorption and insulation performance characteristics that are different for each portion in one component by varying a porosity for each portion having noises in different frequency bands.

In other words, it is possible to respectively respond to the sound absorption and insulation of a frequency component for each portion by varying a perforation layout for each portion in one target component that becomes a noise removal object.

The sound absorption and insulation module 1 is configured as a combination of the metallic perforated panel 10 in which the plurality of holes 11 are formed, the sound absorption material made of a polyurethane foam and a glass fiber, and the sound insulation material 30 made of a polypropylene material, and noises are absorbed by a resonance generated by a specific frequency while passing through the holes 11 of the perforated panel 10, the noises are absorbed in the form of thermal and motion energies by the porous sound absorption material 20, and noises of the remaining frequency components passing through the sound absorption material 20 are finally insulated by the sound insulation material 30.

The sound absorption and insulation module 1 has an advantage in that a noise in a specific frequency band is absorbed by the perforated panel 10, a noise in a broad frequency band is absorbed by the sound absorption material 20, and noises in the remaining frequency components are insulated by the sound insulation material 30, thereby achieving more improved sound absorption and insulation performance.

The sound absorption and insulation module 1 may have a structure in which one surface of the sound absorption material is laminated by being bonded and coupled to one surface of the perforated panel 10, and one surface of the sound insulation material 30 is laminated by being bonded and coupled to the other surface of the sound absorption material 20 and may be installed on numerous portions requiring noise insulation in the vehicle by integrating the sound absorption and insulation module 1, the sound absorption material 20, and the sound insulation material 30, which are sequentially coupled.

In some implementations, since the hole 11 formed in the perforated panel 10 may be formed so that a size of a diameter D1 of the hole 11, the number of holes 11, and a distance L1 between adjacent holes 11 may be different for each portion having noises in different frequency bands in one target component that becomes a noise removal object, it is possible to satisfy all of the characteristics of the sound absorption and insulation performance for each portion in the one target component.

A noise frequency at which the noise is absorbed while passing through the holes 11 formed in the perforated panel 10 may be determined by the size of the diameter D1 of the hole 11, the distance L1 between the holes 11, and a cross-sectional thickness t1 of the perforated panel 10.

In other words, a sound absorption frequency at which the noise is absorbed by the perforated panel 10 further increases as the diameter D1 of the hole 11 becomes larger, the cross-sectional thickness t1 of the perforated panel 10 becomes smaller, the distance L1 between adjacent holes 11 becomes smaller, and a cross-sectional thickness of a sound absorption layer becomes smaller.

As a result, a sound impedance of the perforated panel 10 is inversely proportional to an aperture rate of the hole 11, and as the aperture rate becomes larger, the sound absorption and insulation frequency may increase.

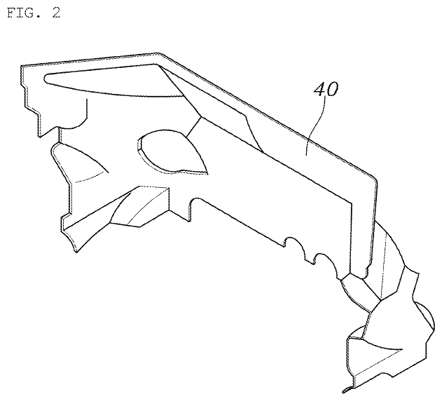

FIGS. 2 to 5 illustrate a process of forming the hole 11 in the perforated panel 10.

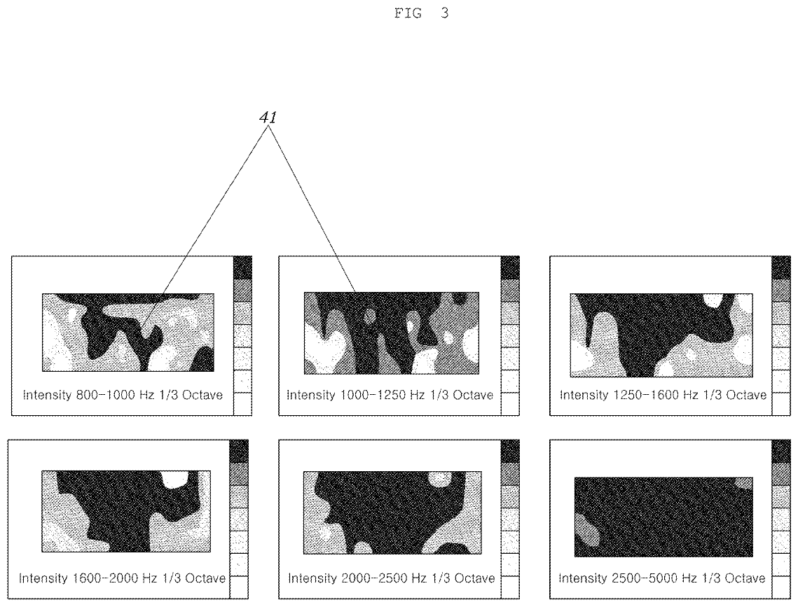

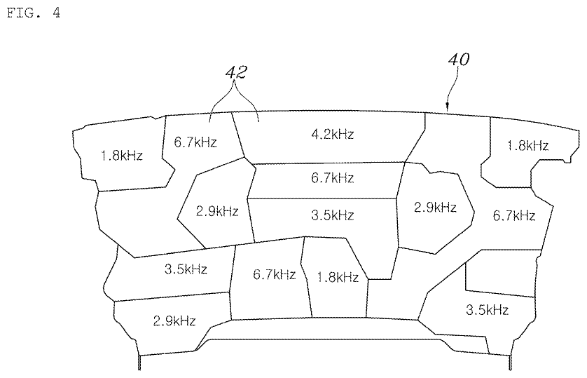

First, a first operation of determining one target component that becomes a noise removal object as illustrated in FIG. 2 and then checking a frequency component and a sound pressure strength 41 of a noise source for each portion in the one target component 40 as illustrated in FIG. 3 is performed, and a second operation of classifying a frequency component 42 for each portion in the target component 40 as illustrated in FIG. 4 with a result value obtained through the first operation is performed.

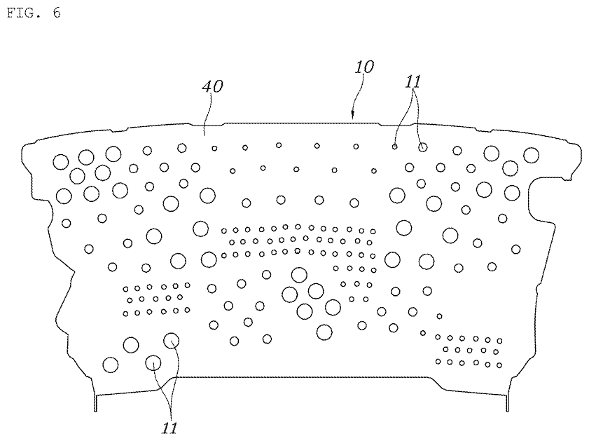

In addition, the plurality of holes 11 having different layouts for each portion of the perforated panel 10 may be finally formed by performing a third operation of selecting the layout of the hole 11 suitable for the frequency component 42 for each portion classified in the second operation as illustrated in FIG. and performing a fourth operation of performing perforation for each portion of the target component 40 as illustrated in FIG. 6 after reflecting the result of the third operation.

The first operation may be performed through a sound intensity evaluation.

In the third operation, the layout of the hole 11 may be selected by using a pre-calculated data map (library) 43, and the layout of the hole 11 may include the size of the diameter D1 of the hole 11, the number of holes 11, and the distance L1 between the holes 11.

Considering the sound absorption frequency for each portion of the sound absorption and insulation system confirmed through the sound intensity evaluation in the first operation and the layout, the material, the thickness, and the like of the sound absorption and insulation system, an appropriate perforation layout may be selected from the pre-calculated data map 43.

After the metal panel performs the fourth operation, the perforated panel 10 in which the plurality of holes 11 having different layouts for each portion are formed is eventually formed, and the perforated panel 10 may satisfy all characteristics of the sound absorption and insulation performance for each portion within one target component.

As illustrated in FIG. 6, since the perforated panel 10 of which a shape has been completed through the fourth operation has different perforation layouts for each portion, the sound absorption and insulation frequency and the sound absorption coefficient for each portion may be different due to a change in porosity.

As described above, when the sound absorption and insulation module 1 is configured by applying the perforated panel 10 formed so that the size of the diameter D1 of the hole 11, the number of holes, and the distance L1 between the holes 11 are different for each portion, it is possible to locally respond to noises in various frequency bands one by one in one target component that becomes a noise removal object, thereby achieving optimal sound absorption and insulation performance while minimizing an increase in weight and cost thereof.

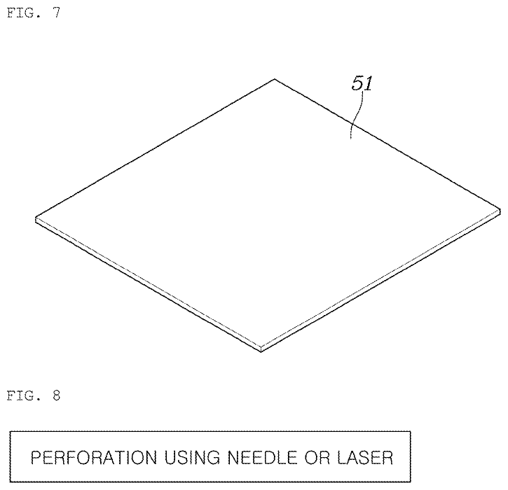

FIGS. 7 to 13 illustrate a process of manufacturing the sound absorption and insulation module 1.

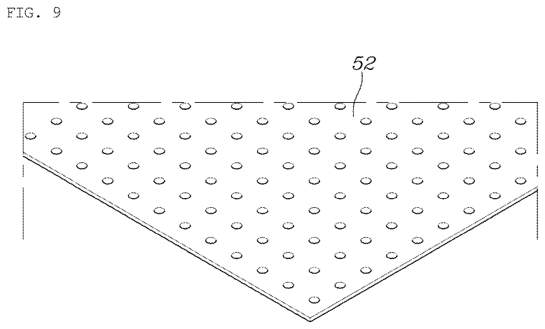

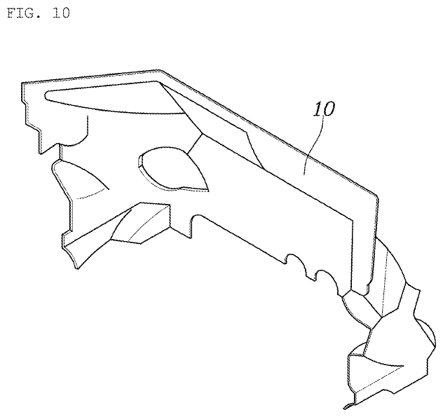

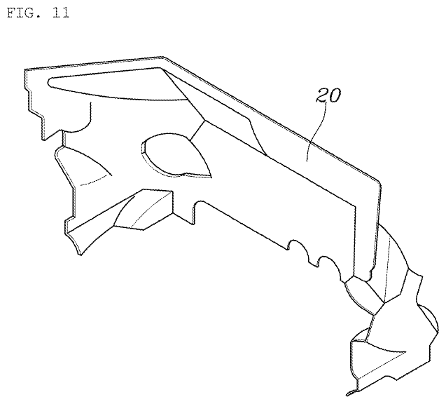

The perforated panel 10 having a predetermined shape is manufactured by first preparing the metal panel 51 having a predetermined cross-sectional thickness as illustrated in FIG. 7, perforating the metal panel 51 using a needle or a laser as illustrated in FIG. 8, forming the perforated panel 52 in which the plurality of holes having different layouts for each portion are formed as illustrated in FIG. 9, and press-molding the perforated panel 52 as illustrated in FIG. 10.

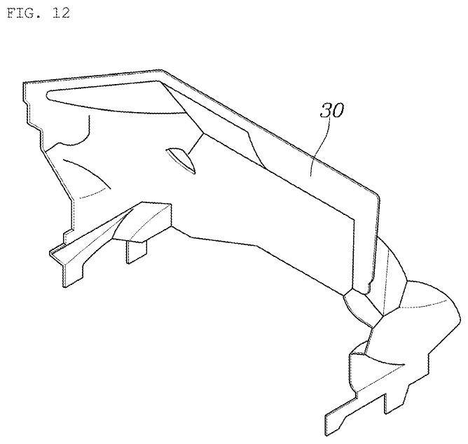

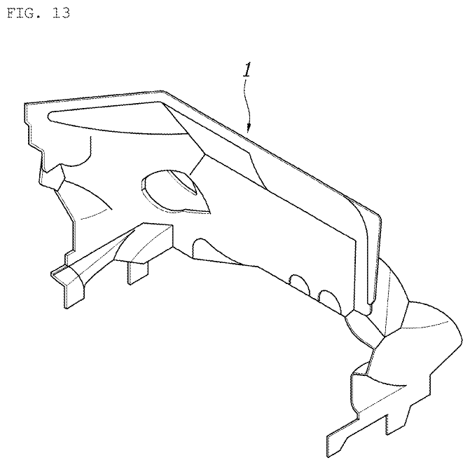

Next, the manufacture of the sound absorption and insulation module 1 may be finally completed by manufacturing the sound absorption material 20 having a shape that is the same as or similar to that of the perforated panel 10 by molding a glass fiber as illustrated in FIG. 11, manufacturing the sound insulation material 30 having a shape that is the same as or similar to that of the perforated panel 10 by injection-molding polypropylene as illustrated in FIG. 12, and sequentially coupling the perforated panel 10, the sound absorption material 20, and the sound insulation material 30, and the sound absorption and insulation module 1 manufactured as described above may be applied to numerous portions requiring noise insulation in the vehicle.

The perforated panel 10 according to a first implementation of the present disclosure may be formed to have a porosity of 0.5 to 3% in a condition in which the cross-sectional thickness t1 is in a range of 0.5 to 3 mm, the distance L1 between the holes 11 is in a range of 3 to 8 mm, and the diameter D1 of the hole 11 is in a range of 0.5 to 1 mm, and the perforated panel 10 formed as described above may be sequentially formed together with the sound absorption material 20 and the sound insulation material 30, thereby more effectively eliminating the noise of the specific frequency in a range of 1 to 3 kHz.

The perforated panel 10 according to a second implementation of the present disclosure may be formed to have a porosity of 2 to 11% in a condition in which the cross-sectional thickness t1 is in a range of 0.5 to 3 mm, the distance L1 between the holes 11 is in a range of 1.5 to 4 mm, and the diameter D1 of the hole 11 is in a range of 0.5 to 2 mm, and the perforated panel 10 formed as described above may be sequentially formed together with the sound absorption material 20 and the sound insulation material 30, thereby more effectively eliminating the noise of the specific frequency in a range of 3 to 7 kHz.

The perforated panel 10 according to a third implementation of the present disclosure may be formed to have a porosity of 10% or more in a condition in which the cross-sectional thickness t1 is in a range of 0.5 to 3 mm, the distance L1 between the holes 11 is in a range of 0.5 to 4 mm, and the diameter D1 of the hole 11 is in a range of 0.2 to 2 mm, and the perforated panel 10 formed as described above may be sequentially formed together with the sound absorption material 20 and the sound insulation material 30, thereby more effectively eliminating the noise of the specific frequency in a range of 7 to 10 KHz.

The perforated panel 10 may be made of a material other than metal having a relatively larger hardness than the sound absorption material 20 and the sound insulation material 30, and in this case, a process of finally manufacturing the perforated panel 10 by manufacturing the perforated panel by perforating the metal panel and press-molding the perforated panel may be applied in the same manner.

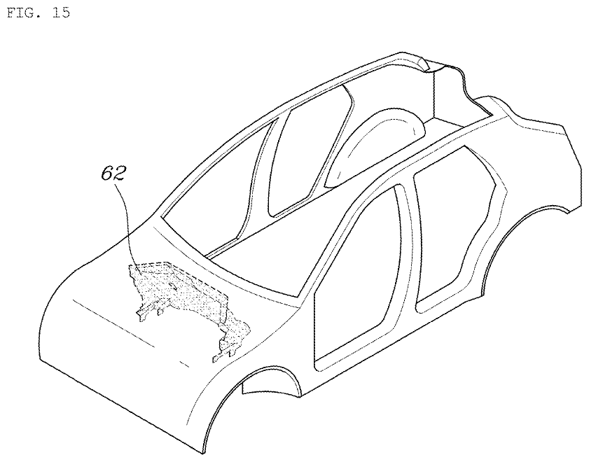

FIGS. 14 to 17 illustrate an example in which a portion to which the sound absorption and insulation module 1 is applied in the vehicle.

As illustrated, the sound absorption and insulation module 1 may be applied to at least one of an insulator 61, a partition wall or encapsulation 62, a carpet and isolation pad 63, and a wheel guard 64.

In other words, as illustrated in FIG. 14, the sound absorption and insulation module 1 may be applied to the insulator 61, which is a sound absorption and insulation system using a motor and an inverter positioned in a power electronics (PE) room as a noise source.

In addition, as illustrated in FIG. 15, the sound absorption and insulation module 1 may be applied to the partition wall or the encapsulation 62, which is a sound absorption and insulation system using a motor, an inverter, or a heating, ventilation, air conditioning (HVAC) blower motor positioned in the PE room as a noise source.

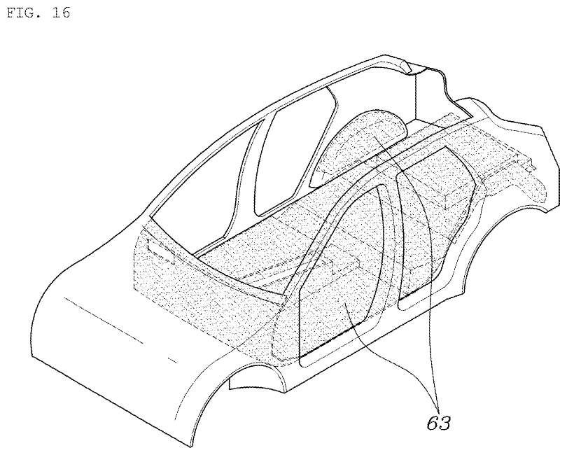

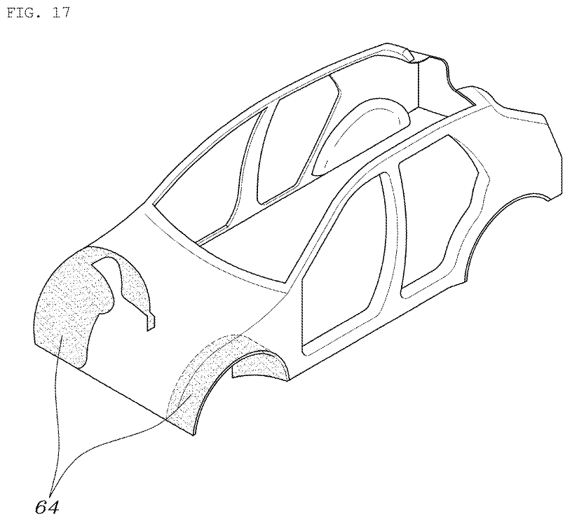

In addition, as illustrated in FIG. 16, the sound absorption and insulation module 1 may be applied to the carpet or the isolation pad 63, which is a sound absorption and insulation system using a road noise transmitted to tires from the ground as a noise source.

In addition, as illustrated in FIG. 17, the sound absorption and insulation module 1 may be applied to the wheel guards 64 of front wheels and rear wheels, which are a sound absorption and insulation system using resonance sounds of the tires as a noise source.

As described above, the sound absorption and insulation module 1 for a vehicle may have the configuration in which the perforated panel 10 in which the plurality of holes 11 are formed, the sound absorption material 20, and the sound insulation material 30 are sequentially coupled integrally, and the holes 11 of the perforated panel 10 are formed so that the size of the diameter D1 of the hole 11, the number of holes 11, and the distance L1 between the holes 11 for each portion having the noises in different frequency bands are different, and may effectively respond to all noises in various frequency bands for each portion in the specific component and in particular, make the entire sound absorption and insulation system slimmer, thereby reducing the weight and cost thereof.

In addition, according to the sound absorption and insulation module 1 for a vehicle, it is possible to target the sound absorption coefficient of the specific portion and the specific frequency using the impedance characteristics of the perforated panel 10 that are different for each portion, thereby constituting the optimal sound absorption and insulation system suitable for the sound characteristics of the target noise source.

In addition, according to the sound absorption and insulation module 1 for a vehicle, it is advantageous in reducing the noise by decreasing the weights of the sound absorption material 20 and the sound insulation material 30 as much as the weight of the perforated panel 10 newly added to the conventional structure, and it is possible to secure the countermeasure for suppressing noises and vibrations by changing only the layout of the hole 11 of the perforated panel 10 while maintaining sound absorption material 20 and the sound insulation material 30 as it is when the noise source is changed.

In addition, according to the sound absorption and insulation module 1 for a vehicle, it is possible to reduce the content of the glass fiber compared to the conventional sound absorption and insulation structure due to the increase in the sound absorption coefficient caused by applying the perforated panel 10, thereby reducing human harm and achieving the excellent eco-friendly property.

Although the specific implementations of the present disclosure have been illustrated and described, it will be apparent to those skilled in the art that the present disclosure may be variously improved and changed without departing from the technical spirit of the present disclosure provided by the appended claims.

What is claimed is:

1. A sound absorption and insulation module for a vehicle, comprising:
a perforated panel that defines a plurality of holes;
a sound absorption material that is porous and disposed on the perforated panel; and
a sound insulation material disposed on the sound absorption material.

2. The sound absorption and insulation module of claim 1, wherein the sound absorption material has:
a first surface that is bonded to a first surface of the perforated panel; and
a second surface that is bonded to a first surface of the sound insulation material.

3. The sound absorption and insulation module of claim 1, wherein one or more diameters of the plurality of holes are determined based on a target component of the vehicle to thereby remove noise generated from the target component.

4. The sound absorption and insulation module of claim 1, wherein a number of the plurality of holes is determined based on a target component of the vehicle to thereby remove noise generated from the target component.

5. The sound absorption and insulation module of claim 1, wherein one or more distances between the plurality of holes are determined based on a target component of the vehicle to thereby remove noise generated from the target component of the vehicle.

6. The sound absorption and insulation module of claim 1, wherein each of (i) one or more diameters of the plurality of holes, (ii) a number of the plurality of holes, and (iii) one or more distances between the plurality of holes is determined based on a target component of the vehicle to thereby remove noise generated from the target component.

7. The sound absorption and insulation module of claim 1, wherein the perforated panel is configured to absorb a sound having a noise frequency corresponding to a size of the plurality of holes, a distance between the plurality of holes, and a cross-sectional thickness of the perforated panel, the sound being absorbed while passing through the plurality of holes in the perforated panel.

8. The sound absorption and insulation module of claim 1, wherein the plurality of holes of the perforated panel are arranged in a layout that is determined by:
a first operation of checking a frequency component and a sound pressure intensity of a noise source for one or more portions of a target component of the vehicle for removing noise,
a second operation of classifying the frequency component based on a result value obtained through the first operation,
a third operation of selecting the layout for the frequency component classified in the second operation, and
a fourth operation of performing perforation corresponding to the one or more portions of the target component based on the layout selected in the third operation.

9. The sound absorption and insulation module of claim 1, wherein the perforated panel comprises a metal panel perforated by press-molding,
wherein the sound absorption material comprises a glass fiber that is molded,
wherein the sound insulation material comprises polypropylene that is injection-molded, and
wherein the perforated panel, the sound absorption material, and the sound insulation material are sequentially coupled.

10. The sound absorption and insulation module of claim 1, wherein a porosity of the perforated panel is 0.5 to 3%,
wherein a cross-sectional thickness of the perforated panel is 0.5 to 3 mm,
wherein a distance between the plurality of holes is 3 to 8 mm,
wherein a diameter of the plurality of holes is 0.5 to 1 mm, and
wherein the perforated panel, the sound absorption material, and the sound insulation material are coupled to one another and configured to eliminate a noise having a frequency in a range of 1 to 3 kHz.

11. The sound absorption and insulation module of claim 1, wherein a porosity of the perforated panel is 2 to 11%,
wherein a cross-sectional thickness of the perforated panel is 0.5 to 3 mm,
wherein a distance between the plurality of holes is 1.5 to 4 mm,
wherein a diameter of the plurality of holes is 0.5 to 2 mm, and
wherein the perforated panel, the sound absorption material, and the sound insulation material are coupled to one another and configured to eliminate a noise having a frequency in a range of 3 to 7 kHz.

12. The sound absorption and insulation module of claim 1, wherein a porosity of the perforated panel is 10% or more,
wherein a cross-sectional thickness of the perforated panel is 0.5 to 3 mm,
wherein a distance between the plurality of holes is 0.5 to 4 mm,
wherein a diameter of the plurality of holes is 0.2 to 2 mm, and
wherein the perforated panel, the sound absorption material, and the sound insulation material are coupled to one another and configured to eliminate a noise in a specific frequency in a range of 7 to 10 KHz.

13. The sound absorption and insulation module of claim 1, wherein the sound absorption and insulation module is configured to be applied to at least one of an insulator, a partition wall, encapsulation, a carpet, an isolation pad, or a wheel guard of the vehicle.

14. The sound absorption and insulation module of claim 1, wherein the perforated panel is made of a material other than metal, the material having a greater hardness than the sound absorption material and the sound insulation material.

15. The sound absorption and insulation module of claim 1, wherein a hardness of the perforated panel is less than a hardness of each of the sound absorption material and the sound insulation material.
